(19) United States
(12) Patent Application Publication
(10) Pub. No.: US 2018/0079830 A1
(43) Pub. Date: Mar. 22, 2018

(54) Enclosed Weather Protection Element With Integrated Adapter Panel For Camping Hammocks

(71) Applicant: WARBONNET OUTDOORS LLC, Evergreen, CO (US)

(72) Inventor: Kenneth Brandon Waddy, Evergreen, CO (US)

(21) Appl. No.: 15/804,139

(22) Filed: Nov. 6, 2017

Related U.S. Application Data
(63) Continuation-in-part of application No. 14/883,520, filed on Oct. 14, 2015.
Application No. 14/883,520 is a division of application No. 12/807,667, filed on Sep. 10, 2010, now Pat. No. 9,192,224.
(60) Provisional application No. 61/276,433, filed on Sep. 11, 2009.

(51) Int. Cl. C08B 3/06

(52) U.S. Cl. CPC C08B 3/06

(57) ABSTRACT

An adapter panel for use with an undercover and canopy for weather protection of a hammock is disclosed. An example includes an undercover having side edges. A canopy with a substantially diamond shape. An adapter panel has a shape corresponding to the shape of the canopy. The adapter panel has a first longitudinal edge and a second longitudinal edge spaced apart by a body of the adapter panel. The adapter panel joins to the undercover along only the first longitudinal edge of the adapter panel. The adapter panel joins to the canopy along only the second longitudinal edge of the adapter panel. The body of the adapter panel joins the undercover to the canopy.

### CROSS REFERENCE TO RELATED APPLICATIONS

This application is a continuation-in-part (CIP) of U.S. patent application Ser. No. 14/883,520 filed Oct. 14, 2015 titled “Covered Hammock with Adapter Panel” of Kenneth Brandon Waddy, which is a divisional of U.S. patent application Ser. No. 12/807,667 filed on Sep. 10, 2010 (U.S. Pat. No. 9,192,224 issued Nov. 24, 2015) titled “Covered Hammock with Adapter Panel” of Kenneth Brandon Waddy, which claims priority from provisional application No. 61/276,433 filed on Sep. 11, 2009, each of which are hereby incorporated by reference as though fully set forth herein.

### BACKGROUND

Some types of hammocks are meant to be used in a camping environment and are designed to perform a similar function to many camping tents. Due to the inherent differences between tents and hammocks, various design elements are employed to achieve the results. One such method for protecting the hammock bottom from severe weather is to implement a secondary layer of fabric that hangs loose below the hammock body, loose enough to allow room for the thickness of any suspended insulation (commonly called an under quilt) that may be attached to the underside of the hammock body. This secondary layer of weather protective fabric is sometimes referred to as an underquilt protector or undercover.

An increasingly common method of cutting down on wind flow coming in up above through the netting is to cover the netting with (or replace it entirely) with a more wind resistant fabric. This design element is often referred to as a topcover.

Another design element combines the 2 items above to form an enclosed capsule or shell (called a “sock” because early models resembled a giant wind sock with the open ends gathered shut). The sock, creating an enclosure around the hammock, its occupant and any and all insulation, creates a weather-resistant microclimate for the whole sleep system and is useful in winter weather type conditions.

Gathered end hammocks may be fitted with canopies or netting. Traditionally, end gathered hammocks (such as those based on Mayan and Brazilian styles) are made from wide pieces of fabric and are meant to be laid in diagonally in order to achieve a flat lay (suitably flat sleeping surface). Lying diagonally in such a hammock naturally forces the loose edges of the hammock body into a certain shape (an asymmetric parallelogram), which is also referred to as “the natural shape of the diagonal position”. This allows the user to achieve a somewhat flat sleeping surface (desirable).

If mosquito netting or other fabric is to be fitted to those loose edges in such a way as to be minimal and tight fitting (often desired for aesthetic and weight reduction purposes), the shape of the canopy used had to resemble the natural shape of the diagonal position (as seen in U.S. Pat. No. 6,865,757). If the shape did not, then it would restrict the hammock body and greatly reduce head/foot room and thus force the user into more of an “in-line” position rather than the preferred “diagonal position” (as seen in U.S. Pat. No. 6,421,851). This loss of diagonal potential decreases both flatness and comfort.

Being restricted to using only the natural shape of the diagonal position for the shape of the canopy/netting in order to achieve comfort and roominess is not nearly as desirable as being able to use almost any shape a designer wishes while still keeping all its benefits.

### BRIEF DESCRIPTION OF THE DRAWINGS

FIG. 1 is an exploded perspective view of an example hammock fitted with an undercover and canopy of the present disclosure.

FIG. 1A shows an example adapter panel.

FIG. 2 is a top perspective view of an example hammock which implemented with an undercover and canopy of the present disclosure.

FIG. 3 is a right side view of the example hammock in FIGS. 1 and 2 with an adapter panel.

FIG. 4 is a left side view of the example hammock in FIGS. 1 and 2 without the adapter panel.

FIG. 5 is a front (e.g., foot-end) view of the example hammock in FIGS. 1 and 2.

FIG. 6 is a back (e.g., head-end) view of the example hammock in FIGS. 1 and 2.

FIG. 7 is a top view of the example hammock in FIGS. 1 and 2.

FIG. 8 is a bottom view of the example hammock in FIGS. 1 and 2.

FIG. 9 is a top perspective view of the hammock body and undercover.

FIG. 10 is a right side view of the example hammock body and undercover.

FIG. 11 is a left side view of the example hammock body and undercover.

FIG. 12 is a front view of the example hammock body and undercover.

FIG. 13 is a back view of the example hammock body and undercover.

FIG. 14 is a top view of the example hammock body and undercover.

FIG. 15 is a bottom view of the example undercover and shelf portion of the adapter panel.

FIG. 16 shows an example hammock body and undercover with a diagonally laying occupant with a pair of glasses and flashlight stored in the shelf.

FIG. 17 shows the adapter panel illustrating how the adapter panel twists in use versus its actual shape.

### DETAILED DESCRIPTION

An undercover is disclosed as it may be implemented with an often-used combination of hammock body and attached top canopy/mosquito netting. It may also be implemented with the hammock of co-owned U.S. Pat. No. 9,192,224, which also incorporates an adapter panel. The adapter panel is attached between the edge of the undercover and the edge of the top-canopy. The adapter panel acts like an adapter, allowing the undercover itself, and the hammock it's covering, to assume the general natural shape of the diagonal position exerted on them by the user (which is needed for proper comfort) while allowing one to use just about whatever shape they wish for the shape of the canopy, and doing this without having to worry about causing any restriction to the hammock body inside (so as not to negatively affect diagonal lay/position/comfort/roominess/etc.). In addition, the adapter panel also creates a large out-of-the-way storage shelf. This is extremely beneficial, as storage space is commonly lacking in current hammock designs and is particularly needed in the camping hammock variety.

Certain embodiments of the hammock accessory include an adapter panel connecting (by means of existing between) an undercover and a canopy (which can have various shapes). The canopy and undercover can both be made of fabrics of various weaves, or nonwoven materials, ranging from closely woven, opaque materials to mesh or netting. Commercial insect netting materials of various types can be used, possibly even comprising metal or plastic fibers as alternatives to cloth fabrics.

Thanks to the use of the adapter panel (often made of solid fabrics similar to those used in the hammock body), which is fitted between the edge of the undercover and the edge of the canopy, the canopy can now have almost any shape. The adapter panel eliminates any need for the shape of the canopy to conform to the desired contours of the edge of the occupied hammock body or undercover.

The edges of the top canopy can be provided with attachments for lines, which can be used to exert tension on the sides to spread the top canopy out. The terms “head” and “foot” signify the ends of the adapter panel closest to the head and feet, respectively, of an occupant in the hammock.

The adapter panel, which comprises at least two sides or edges, resides between the edge of the undercover and the edge of the canopy and can have almost any shape. That shape is determined as follows: one edge of the adapter panel will conform to the contour or form of the edge of the undercover as it is shaped by the hammock being occupied beneath it and the other edge of the adapter panel will conform to the contour or form of the edge of the chosen canopy shape. The function of the adapter panel (aside from creating a storage shelf and maximum legroom) is to allow the two differently contoured edges (no matter how different they are from one another) to be precisely fitted together by means of the adapter panel positioned between them. Another way of understanding this arrangement is to think of the undercover and attached top canopy as somewhat like a hollow tube of fabric that tapers toward the ends with space for a hammock body to hang inside of. The adapter panel is shaped in such a way that it adds girth in areas that need it so that the tapering shape of the canopy won't pull the hammock body out of the desired position so as not to restrict room in the head and foot areas. By adding fabric/girth in a few strategic spots, unwanted restriction to the hammock body can be avoided. The location of these key spots would of course be very dependent on the shape of canopy used and the needs of the designer. The preferred embodiment of the concept is designed specifically for one shape of canopy, and it adds fabric only where it is needed, and only in the needed amount. This avoids loose excess fabric in spots where it isn't needed, saves weight and is the main force behind giving the adapter panel its unique, fitted shape. Changing the shape of the canopy while using the same design tactics would alter the shape of the adapter panel.

The edge of the adapter panel that attaches to the undercover will preferably conform to something that generally resembles the natural shape of the diagonal position (or rather one edge/side/half of such a shape) so as to allow the loose edges of the hammock body to take on this desired shape when occupied inside. The other edge of the adapter panel conforms to the contours along the edge of the canopy, which thanks to the adapter panel, is no longer limited in its shape. The relationship between the two is such that the shape chosen for the shape of the canopy will determine the contour that one edge of the adapter panel will need to conform to. The preferred embodiment (the shapes of which were chosen for practical purposes and are in no way mandatory) has an adapter panel with a narrow mid-section and wider portions towards the ends, which correspond to the head and foot ends of the hammock when installed. The end of the adapter panel attached to the canopy adjacent the head-end of the hammock body can be termed the “shelf portion” of the adapter panel, as it creates a flat area adjacent to the occupant's head inside and provides a shelf area for storage of personal effects. Similarly, the opposite end of the adapter panel can be termed the “footbox portion”, as it allows that portion of hammock body to protrude freely where the canopy would otherwise force it to taper. While in prior art covered hammocks (such as U.S. Pat. No. 6,865,757) the canopy is specifically shaped to conform to the desired shape of the suspended, occupied hammock to avoid adverse effects to the hammock body (which would cause discomfort and loss of interior space, particularly in the head and foot areas, to the occupant). The embodiments disclosed herein provide for the installation of adapter panels to join undercovers and canopies of various shapes and sizes in a manner which allows the edges of the suspended hammock body inside to smoothly assume the basic natural shape or orientation of a “diagonal body position” when occupied regardless the shape of the canopy. Naturally, certain adjustments in the contours and shapes of the canopy, adapter panel, and undercover will be necessary for hammock bodies of various proportions and shapes may be altered significantly to provide larger or smaller shelf or footbox areas in the occupied hammock. Additionally, different shapes altogether could be employed. For example, certain different shapes will allow for multiple shelves in different locations if so desired, or the shapes might be changed in order to incorporate different shaped canopies for purely aesthetic reasons. As mentioned above, the presence of a shelf inside the hammock is particularly desirable for camping use so the canopy shape might even be changed or chosen simply to facilitate a change to the shelf portion of the adapter panel. Designing for a bigger shelf, one with a different shape, or simply wanting it in a different location would affect the shape of the adapter panel as well.

Connecting a top canopy to an undercover by means of an adapter panel between them provides all the benefits above regarding comfort, fit and storage space, but the enclosed space that creates around the hammock body also gives an extra level of warmth and weather protection to the user.

The connections between the adapter panel, canopy, and undercover can be permanent as with conventional sewn, riveted, or cemented seams, or can employ temporary attachments along at least one of the connection seams to provide for removable attachment of the canopy or adapter panel components to the undercover. This can be useful when no undercover is needed (such as when the weather is milder). The main requirement is that the edges are sufficiently joined to one another; how they are joined is much less crucial. The four most common attachment methods would likely be sewn or welded seams for permanent attachment and zipper or hook and loop combination (like Velcro) for removable attachment.

Thus, the embodiments disclosed herein provide an improvement on a hammock undercover having a canopy attached removably or permanently, by providing an adapter panel attached removably or permanently between the undercover and the canopy to connect an edge of a canopy to an edge of an undercover. The adapter panel is shaped and attached between the undercover and canopy so as to permit the hammock body inside to assume a proper shape when occupied regardless of the shape of the canopy and creates a storage area.

Before continuing, it is noted that as used herein, the terms “includes” and “including” mean, but is not limited to, “includes” or “including” and “includes at least” or “including at least.” The term “based on” means “based on” and “based at least in part on.”

It is further noted that the examples shown and described herein are provided for purposes of illustration, and are not intended to be limiting. Other devices and/or device configurations may be utilized to carry out the operations described herein.

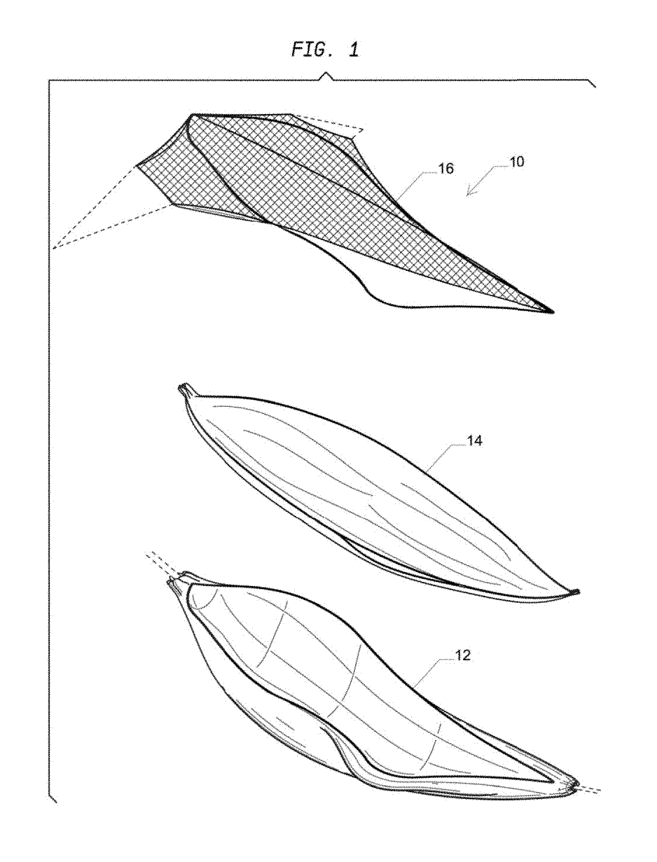

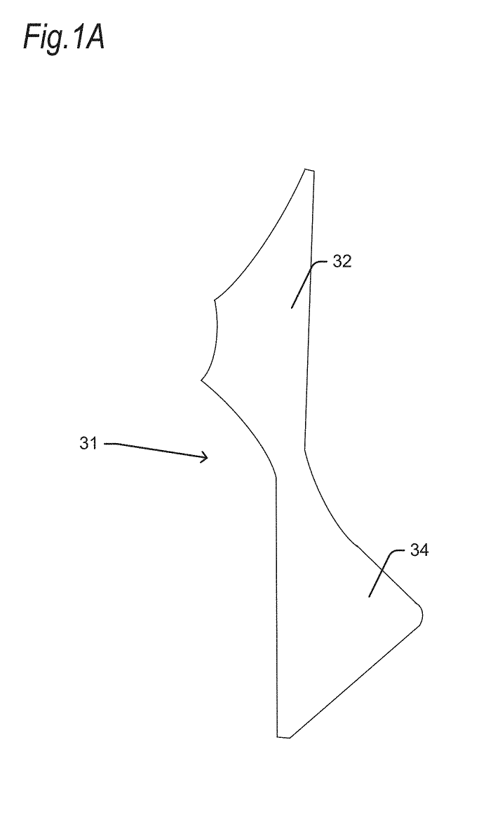

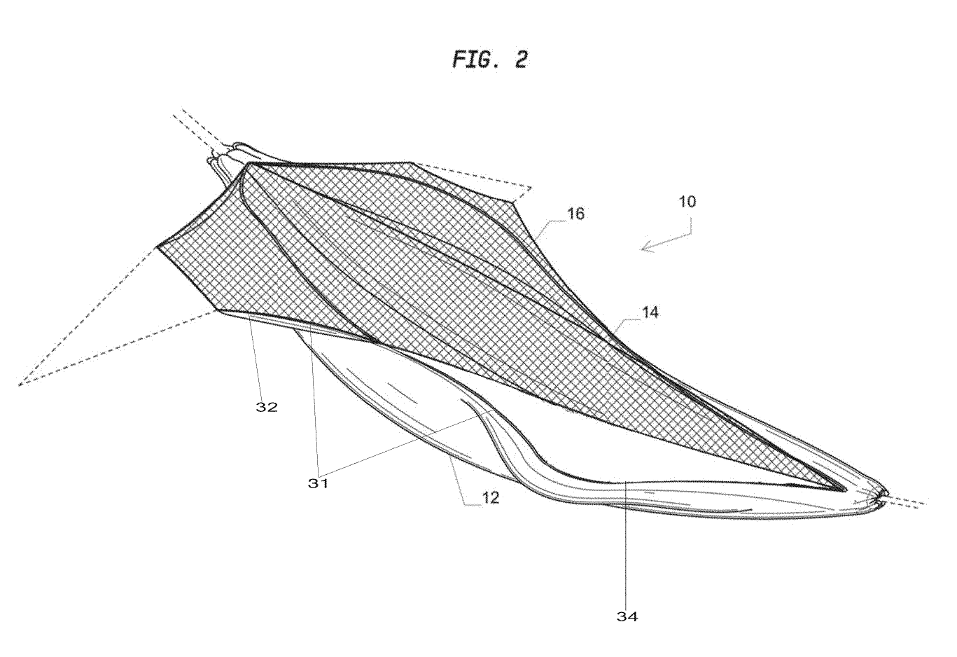

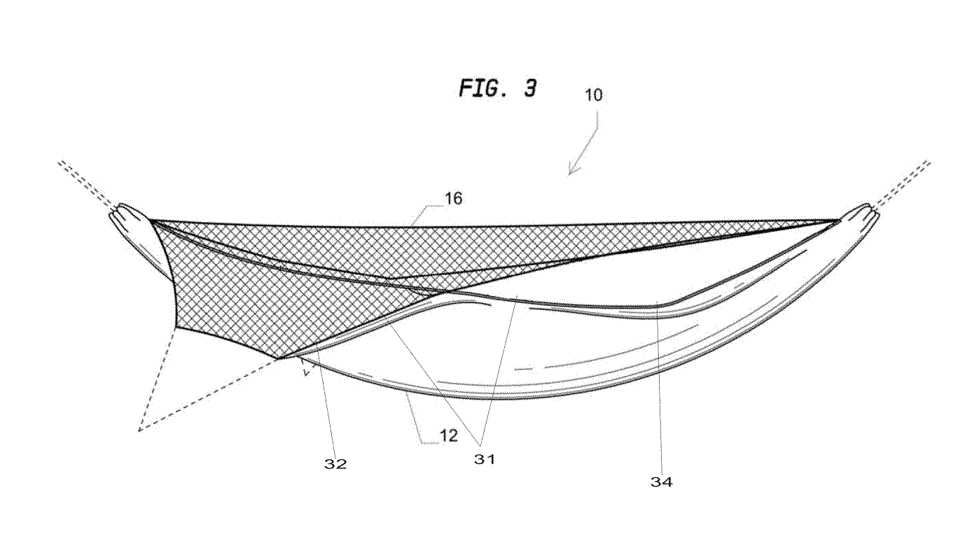

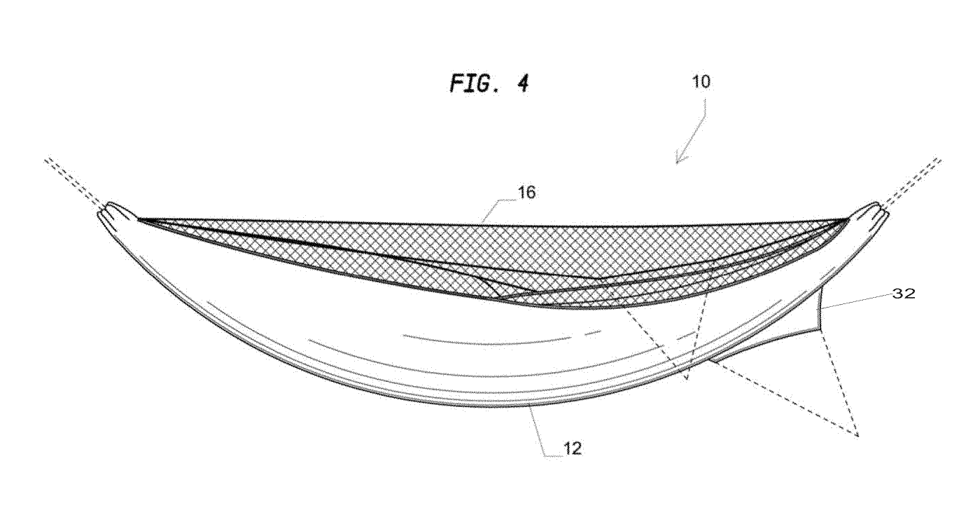

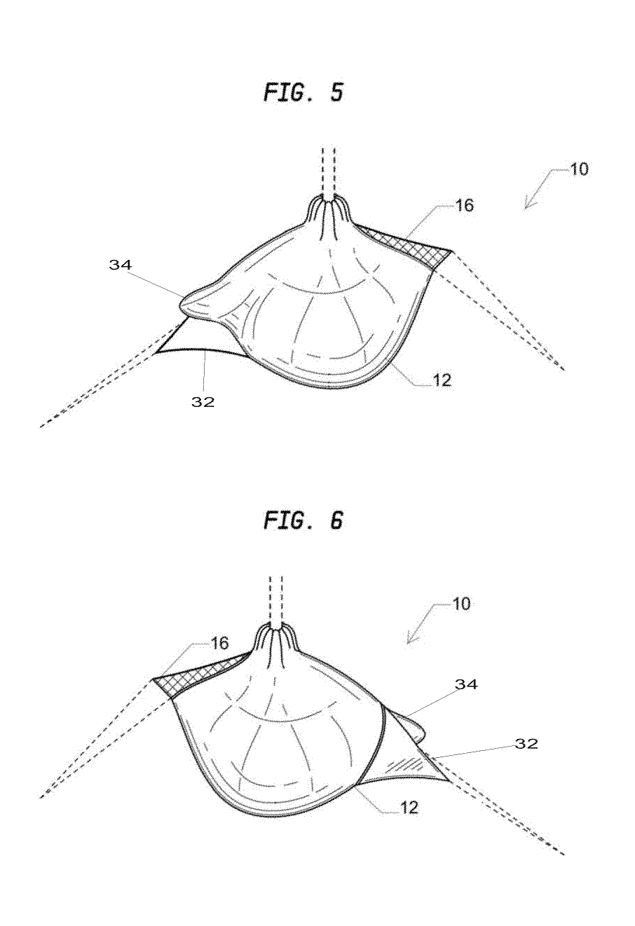

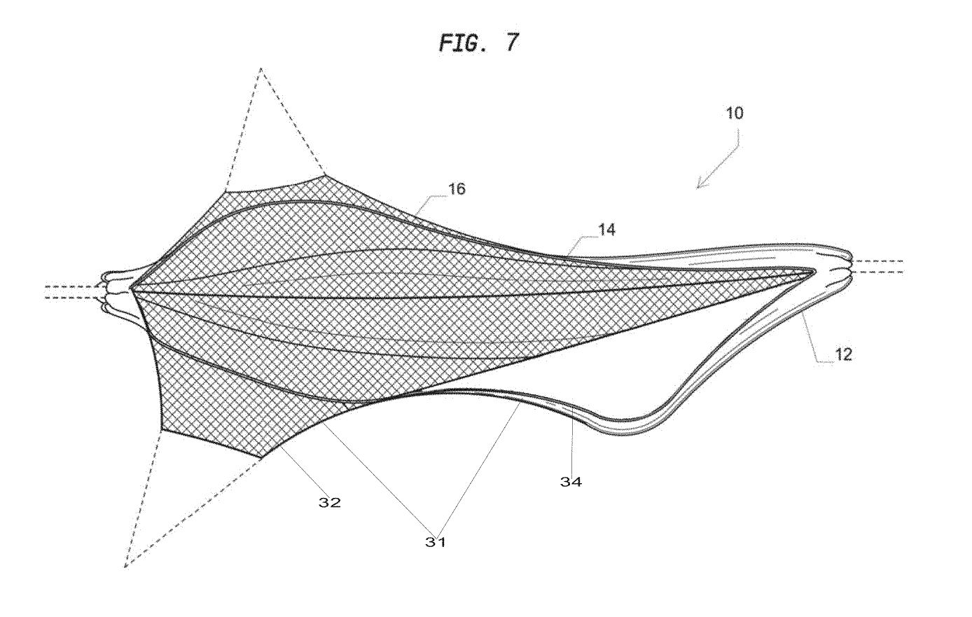

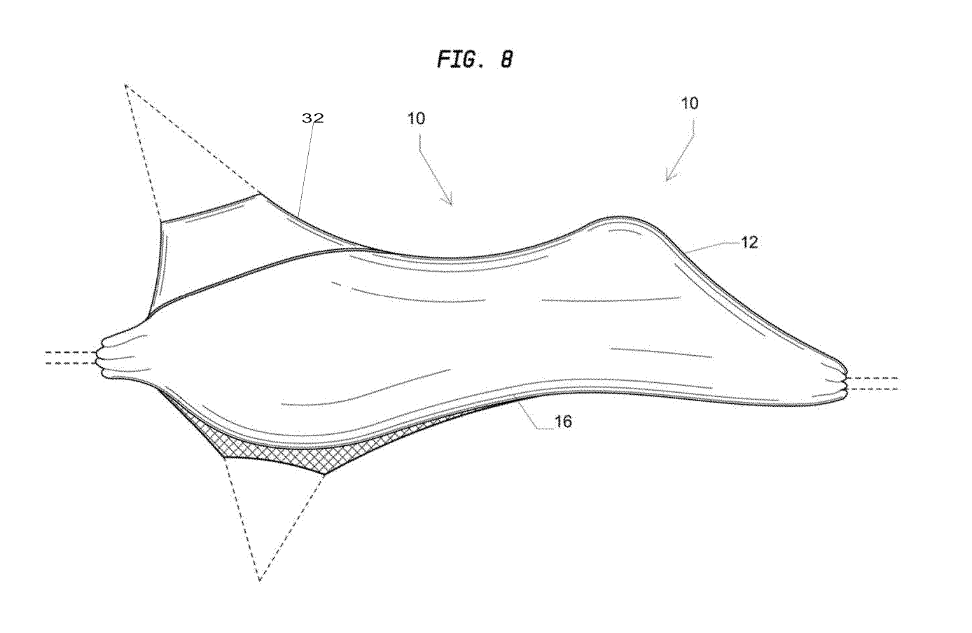

FIG. 1 is an exploded perspective view of an example hammock 10 which may be implemented with an undercover 12 of the present disclosure. FIG. 1A shows an example adapter panel 31. The example adapter panel 31 has two main parts, the shelf portion 32 and the footbox portion 34. FIG. 2 is a top perspective view of an example hammock 10 which may be implemented with an undercover 12 of the present disclosure. FIG. 3 is a right side view of the example hammock 10 in FIGS. 1 and 2. FIG. 4 is a left side view of the example hammock 10 in FIGS. 1 and 2. FIG. 5 is a front (e.g., foot-end) view of the example hammock 10 in FIGS. 1 and 2. FIG. 6 is a back (e.g., head-end) view of the example hammock 10 in FIGS. 1 and 2. FIG. 7 is a top view of the example hammock 10 in FIGS. 1 and 2. FIG. 8 is a bottom view of the example hammock 10 in FIGS. 1 and 2.

In an example, hammock 10 includes a hammock body 14, that is inside of an envelope that is formed from the combination of undercover 12 and top canopy 16, with hammock body 14 hanging inside of said envelope. The canopy 16 may have a substantially diamond shape. The canopy 16 joins to the undercover 12 along one of the side edges of the undercover 12.

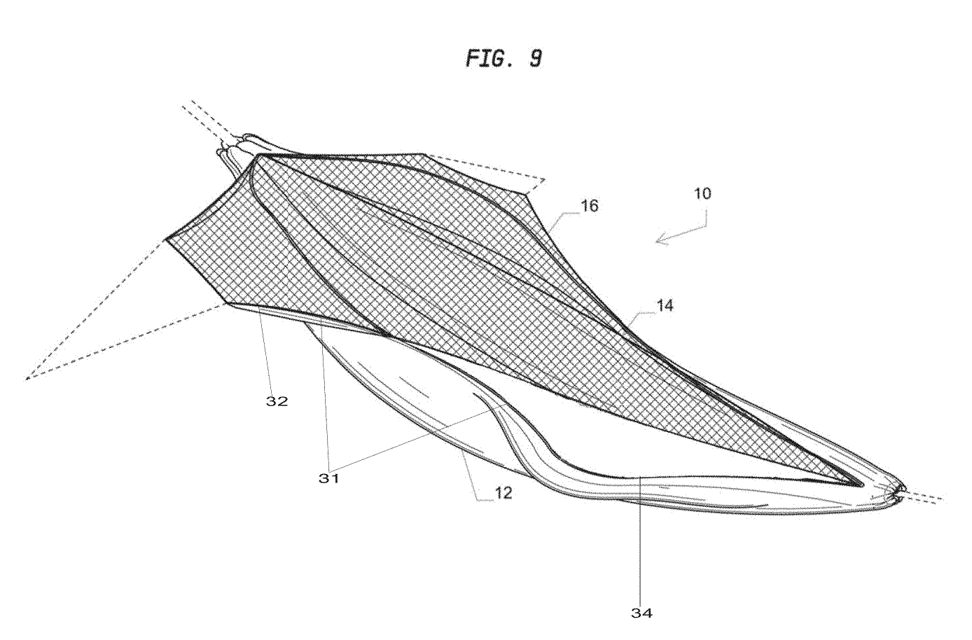

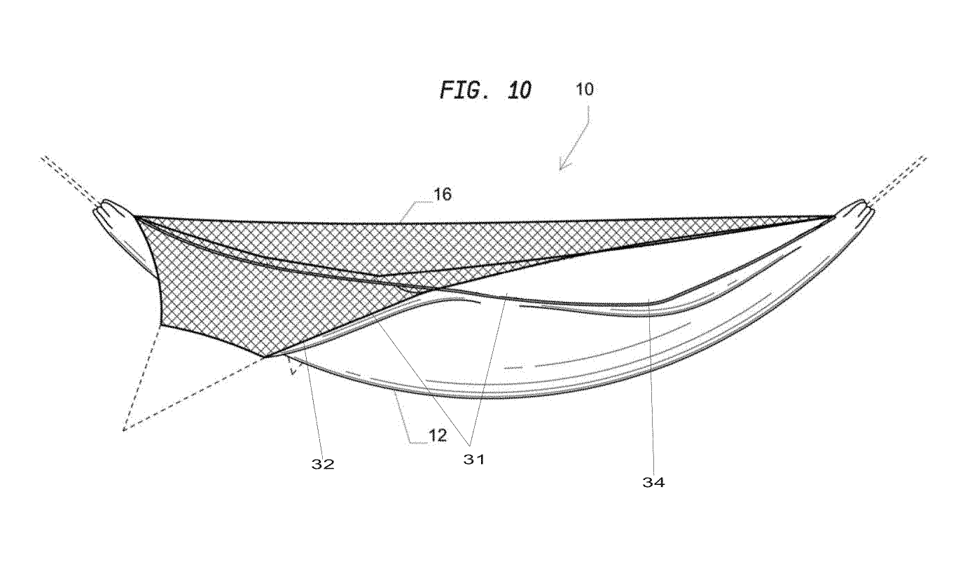

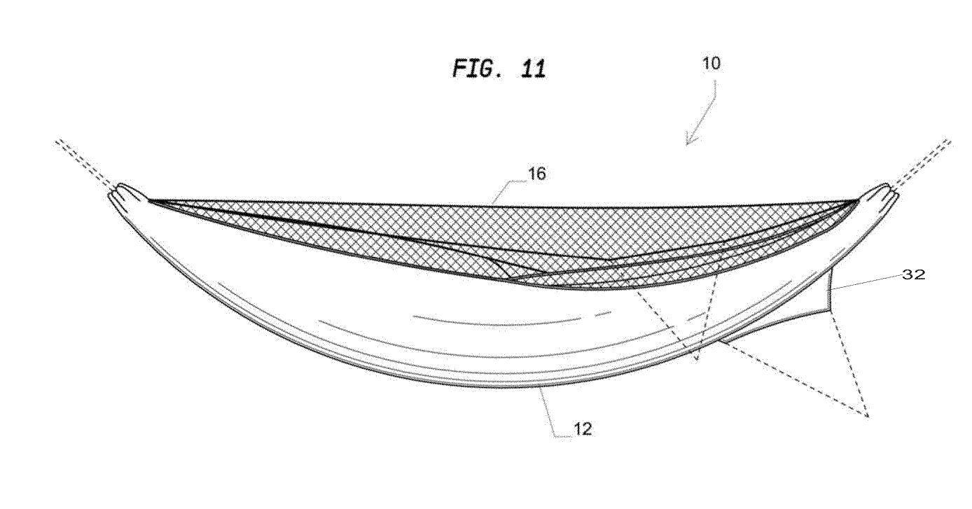

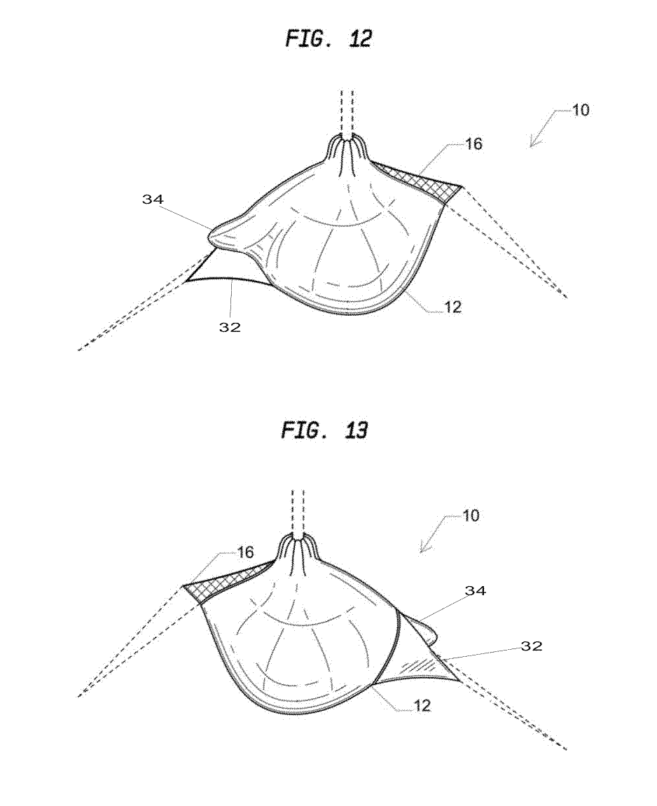

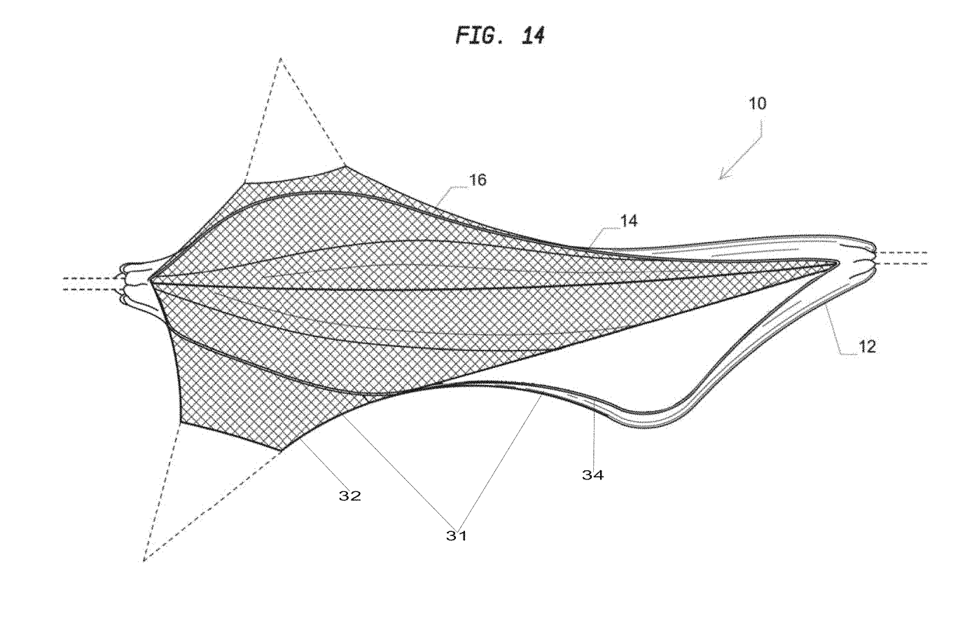

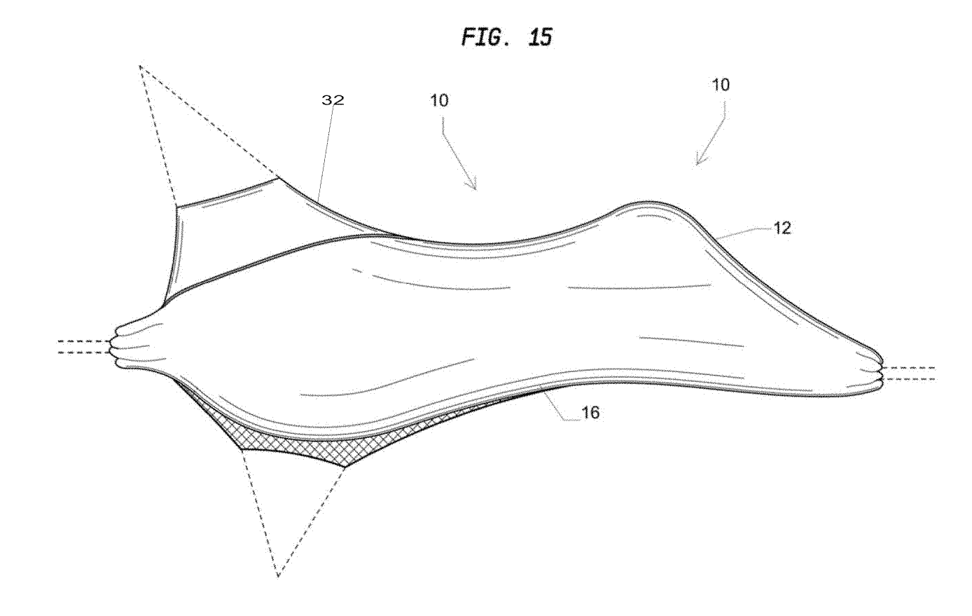

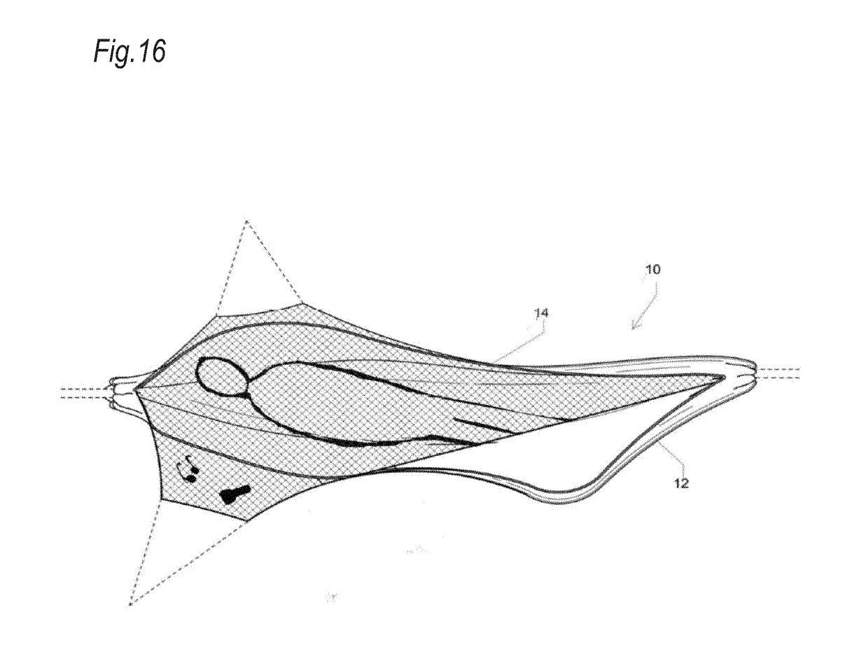

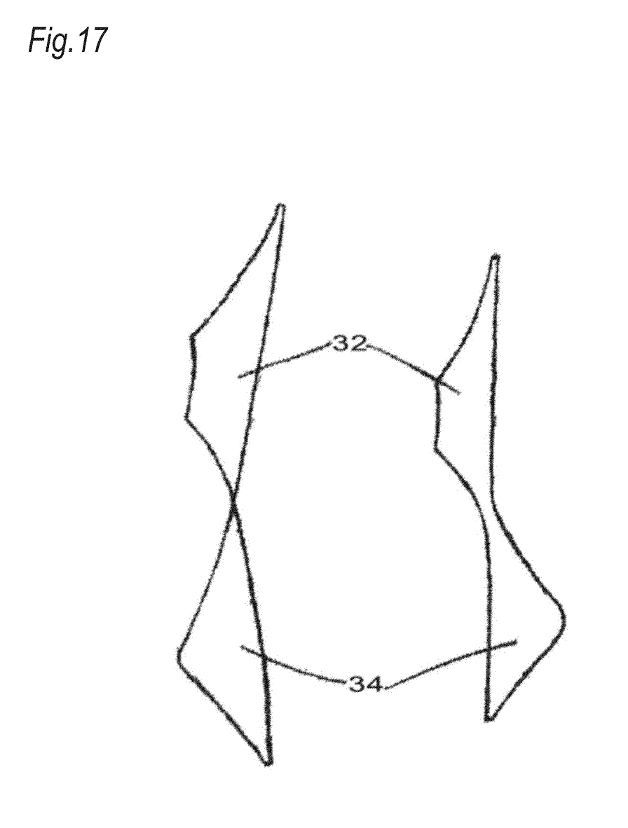

FIGS. 9-17 are various views of the hammock body 14 and undercover 12. The example hammock 10 includes a hammock body 14 (under top canopy 16). The hammock body 14 has side edges and end edges. The canopy 16 may have a substantially diamond shape. The canopy 16 joins to the hammock body 14 along one of the side edges of the hammock body 14.

The example hammock 10 also includes an adapter panel 31. Any suitable adapter panel 31 may be provided. An example adapter panel 31 is shown and described in parent U.S. patent application Ser. Nos. 14/883,520 and 12/807,667, both referenced above. In an example, the adapter panel 31 has a shape corresponding to the shape of the canopy 16. The adapter panel 31 has a first longitudinal edge and a second longitudinal edge spaced apart by a body of the adapter panel 31. The adapter panel 31 joins to the hammock body 14 along only the first longitudinal edge of the adapter panel 31. The adapter panel 31 joins to the canopy 16 along only the second longitudinal edge of the adapter panel 31. The body of the adapter panel 31 joins the hammock body 14 to the canopy 16.

In an example, the undercover 12 is attached to one longitudinal edge or side of the adapter panel 31, and the canopy 16 is attached to the other longitudinal edge or side of the adapter panel 31.

The example hammock 10 also includes an undercover 12. The undercover 12 is attached along at least a part of a perimeter where the adapter panel 31 joins the hammock body 14 and the canopy 16.

A footbox 34 may also be formed at an intersection of the undercover 12 joining to adapter panel 31. In an example, the footbox 34 is formed from a portion of the undercover 12 and adapter panel 31.

In an example, the second longitudinal edge of the adapter panel 31 is on an opposite side of the adapter panel 31 from the first longitudinal edge of the adapter panel 31.

In an example, a shelf is formed at an intersection of said canopy 16 joining to said adapter panel 31. The shelf is formed from a portion of the adapter panel 31. A footbox 34 is formed at an intersection of said hammock body 14 joining to the adapter panel 31. The footbox 34 is formed from a portion of the hammock body 14.

In an example, at least a portion of the canopy 16 is netting.

In an example, the adapter panel 31 is shaped substantially as an hour glass, having a narrow middle portion and large end portions.

In an example, the adapter panel 31 forms a shelf or pocket for storage adjacent at least one end of the hammock body.

In an example, the adapter panel 31 has a head end and a foot end, the foot end providing foot room.

In an example, the foot end of the adapter panel 31 is substantially triangular in shape.

In an example, the foot end of the adapter panel 31 is at least partly incorporated into the shape of the canopy 16.

In an example, the adapter panel 31 has one edge conforming to the contour of one edge of the undercover 12 and an opposite edge conforming to the contour of an edge of the top canopy 16, with the adapter panel 31, the under cover 12, and the top canopy 16 being attached along their edges.

In an example, the edge of the adapter panel 31 is attached to the edge of the undercover 12 and conforms to the natural shape of the diagonal position to enable the loose edges of the undercover 12 and hammock body 14 to assume a desired shape when in use.

In an example, the adapter panel 31 is removably attached to the undercover 12. In an example, the adapter panel 31 is removably attached to the undercover 12 by a zipper. In another example, the adapter panel 31 is removably attached to the undercover 12 by hook-and-loop combinations.

It is noted that the examples shown and described are provided for purposes of illustration and are not intended to be limiting. Still other examples are also contemplated.

1. A weather protection element for a hammock consisting of:
an undercover having side edges;
an adapter panel; and
a canopy having a substantially diamond shape and attached to the adapter panel on at least one side;
wherein the adapter panel has a shape corresponding to the shape of the canopy, the adapter panel having a first longitudinal edge and a second longitudinal edge spaced apart by a body of the adapter panel, the adapter panel joining to the undercover along only the first longitudinal edge of the adapter panel, and the adapter panel joining to the canopy along only the second longitudinal edge of the adapter panel, wherein the body of the adapter panel joins the undercover to the canopy.

2. The hammock accessory of claim 1 wherein the second longitudinal edge of the adapter panel is on an opposite side of the adapter panel from the first longitudinal edge of the adapter panel.

3. The hammock accessory of claim 1 further comprising:
a shelf formed at an intersection of said canopy joining to said adapter panel, said shelf formed from a portion of said adapter panel; and
a foot box formed at an intersection of said undercover joining to said adapter panel, said foot box formed from a portion of said undercover.

4. The hammock accessory of claim 1 wherein at least a portion of the canopy comprises netting.

5. The hammock accessory of claim 1 wherein the adapter panel is shaped substantially as an hour glass, having a narrow middle portion and large end portions.

6. The hammock accessory of claim 1 wherein the adapter panel forms a shelf or pocket for storage adjacent at least one end of the undercover.

7. The hammock accessory of claim 1 wherein the adapter panel has a head end and a foot end, the foot end providing foot room.

8. The hammock accessory of claim 7 wherein the foot end of the adapter panel is substantially triangular in shape.

9. The hammock accessory of claim 7 wherein the foot end of the adapter panel is at least partly incorporated into the shape of the canopy.

10. The hammock accessory of claim 1 wherein said adapter panel has one edge conforming to the contour of one edge of the undercover and an opposite edge conforming to the contour of an edge of the canopy, with the adapter panel, the undercover and the canopy being attached along the edges.

11. The hammock accessory of claim 10 wherein the edge of the adapter panel attached to the edge of the undercover conforms to a natural shape of a diagonal position to enable loose edges of the hammock body to assume a desired shape when in use.

12. The hammock accessory of claim 1 wherein the adapter panel is removably attached to the undercover.

13. The hammock accessory of claim 1 wherein the adapter panel is removably attached to the undercover by zipper.

14. The hammock accessory of claim 1 wherein the adapter panel is removably attached to the undercover by hook-and-loop combinations.

15. A hammock accessory comprising:
an undercover;
a canopy;
an adapter panel having a body with opposite longitudinal edges;
the canopy attached to the adapter panel on at least one side, the body of the adapter panel attached between the edges of the canopy and edges of the undercover, the at least one adapter panel joining to the undercover along only one of a first longitudinal edge, and the at least one adapter panel joining to the canopy along a second longitudinal edge, wherein the body of the adapter panel spans between the opposite longitudinal edges of the adapter panel to join the undercover to the canopy.

16. The hammock accessory of claim 15 wherein at least a portion of the canopy comprises netting.

17. The hammock accessory of claim 15 wherein the adapter panel is shaped substantially as an hour glass.

18. The hammock accessory of claim 15 wherein the adapter panel has a narrow mid-section and wider portions toward the ends, corresponding to the head and foot ends of the hammock body when installed.

19. The hammock accessory of claim 15 wherein the canopy has a substantially tear-drop shape or a substantially diamond shape.

20. The hammock accessory of claim 15 where the canopy, adapter panel, and undercover combine to create an enclosed, weather-resistant shell that protects any hammock hanging inside it.

21. A hammock accessory comprising:
a undercover having side edges and end edges;
at least one adapter panel;
a canopy having a substantially tear-drop shape, the canopy joining to an adapter panel along one of the side edges of the undercover;
wherein the adapter panel has a shape corresponding to the shape of the canopy, the adapter panel having a first longitudinal edge and a second longitudinal edge spaced apart by a body of the adapter panel, the adapter panel joining to the undercover along only the first longitudinal edge of the adapter panel, and the adapter panel joining to the canopy along only the second longitudinal edge of the adapter panel, wherein the body of the adapter panel joins the undercover to the canopy;
wherein the adapter panel twists for use.

22. The hammock accessory of claim 21, further comprising an adapter panel on both sides of the canopy.

23. The hammock accessory of claim 21, wherein storage space is created that is not inside a perimeter of a hammock body

24. The hammock accessory of claim 23, wherein the storage space protrudes outward so as not to take up precious interior space that the user is occupying.
